(19) United States
(12) Patent Application Publication
(10) Pub. No.: US 2025/0024812 A1
(43) Pub. Date: Jan. 23, 2025

(54) POTTY TRAINING DEVICE AND EXCREMENT PROCESSOR INCLUDING SAME

(71) Applicant: Myeong Jin HWANG, Seoul (KR)

(72) Inventor: Myeong Jin HWANG, Seoul (KR)

(21) Appl. No.: 18/769,433

(22) Filed: Jul. 11, 2024

(30) Foreign Application Priority Data
Jul. 17, 2023 (KR) 10-2023-0092531
Sep. 27, 2023 (KR) 10-2023-0130413

(51) Int. Cl. A01K 1/01

(52) U.S. Cl. CPC A01K 1/0121

(57) ABSTRACT

A potty training device includes: a support body providing an internal space where a pet is able to enter and defecate; and an inducer receptor disposed in the internal space of the support body and providing a first inducer receiving space in which a defecation inducer is contained, wherein the support body includes: a support plate supporting the inducer receptor on an upper surface thereof and having a defecation hole through which excrement of the pet passes; and a wall protruding upward from the upper surface of the support plate to accommodate the inducer receptor and having an entrance formed on one side such that the pet is able to enter and exit the support body, and wherein the entrance is disposed near the defecation hole.

### TECHNICAL FIELD

The present disclosure relates to a potty training device and an excrement processor including the same.

### BACKGROUND

With the rise of single-person households and the booming pet industry, more and more households are raising dogs, cats, and various other pets, and one of the biggest challenges in pet care is excrement disposal.

Cats have a natural tendency to seek out sand or gravel to defecate without any specific training. However, there are problems with sand management, such as getting sand on cats' paws and transferring the sand to other locations in the house, creating dust, and making the sand smell bad

There is special sand on the market to address the above problems, but due to the grooming habits of cats, the sand dust on their paws may be absorbed into their bodies.

In addition, flushable litter boxes have been developed to address the problems due to sand use. This relates to a training method that simply places a sand plate on top of the litter box or gradually reduces the size of the sand plate, but cats are not easily trained by the above method.

### PRIOR ART DOCUMENT

### Patent Document

(Patent Document 1) Korean Patent Application Publication No. 10-2018-0136178 (Published on Dec. 24, 2018)

### SUMMARY

In view of the above, the present disclosure provides a potty training device for encouraging pets to defecate and an excrement processor including the same.

In accordance with a first embodiment of the present disclosure, there is provided a potty training device including: a support body providing an internal space where a pet is able to enter and defecate; and an inducer receptor disposed in the internal space of the support body and providing a first inducer receiving space in which a defecation inducer is contained, wherein the support body includes: a support plate supporting the inducer receptor on an upper surface thereof and having a defecation hole through which excrement of the pet passes; and a wall protruding upward from the upper surface of the support plate to accommodate the inducer receptor and having an entrance formed on one side such that the pet is able to enter and exit the support body, and wherein the entrance is disposed near the defecation hole.

Further, in the potty training device, one or more separate receptors detachably may be coupled to the wall and providing a second inducer receiving space in which a defecation inducer is contained, wherein the separate receptors may be coupled to the wall to be located between the entrance and the inducer receptor.

Further, in the potty training device, at least a portion of the wall may extend in a horizontal direction such that the entrance is disposed closer to the defecation hole than the other side opposite one side, a guide groove extending in an up-down direction may be formed on an inner surface of the wall, and each separate receptor includes: a separate receiving part providing the second inducer receiving space and having an opening such that the defecation inducer is contained in the second inducer receiving space; and a protrusion protruding from an outer surface of the separate receiving part toward the wall and engaged with the guide groove to slide in the up-down direction.

Further, in the potty training device, a plurality of guide grooves may be provided, the plurality of guide grooves may be arranged to be spaced apart from each other in a direction in which the wall extends, a plurality of separates receptor may be provided, and one of the plurality of separate receptors may be engaged with one of the plurality of guide grooves, and another one of the plurality of separate receptors may be engaged with another one of the plurality of guide grooves.

Further, in the potty training device, each separate receptor may be coupled to the wall to be disposed in an inducer receiving state for receiving the defecation inductor in the second inducer receiving space or a footrest state for supporting the pet entering and exiting the internal space, and the separate receiving part may be disposed such that the opening faces upward in the inducer receiving state and disposed such that the opening faces downward in the footrest state.

Further, in the potty training device, the separate receiving part includes: a first separation plate; a second separation plate disposed to be spaced apart from the first separation plate in the direction in which the wall extends; a third separation plate connected to the first separation plate and the second separation plate; and a fourth separation plate connected to edges of the first separation plate, the second separation plate, and the third separation plate and supporting the protrusion, wherein the third separation plate may be disposed such that the defecation inductor is supported on one surface in the inducer receiving state and disposed such that the pet is supported on the other surface opposite to the one surface in the footrest state.

Further, in the potty training device, one side of the third separation plate may be connected to the first separation plate, the other side opposite the one side may be connected to the second separation plate, and the third separation plate may be disposed such that the one side is located lower than the other side in the inducer receiving state.

Further, in the potty training device, the support body further includes a receptor support protruding from an inner surface of the support plate and extending in one direction to support the separate receptor, and the fourth separation plate may be supported on the receptor support in the inducer receiving state or the footrest state.

Further, in the potty training device, a plurality of receptor supports may be provided and disposed to be spaced apart from each other in the one direction, a plurality of guide grooves may be provided, the plurality of guide grooves being disposed to be spaced apart from each other in the one direction, the fourth separation plate may have a locking groove formed to be recessed downward from the top in the inducer receiving state, the protrusion may be engaged with one of the plurality of guide grooves, and any one of the plurality of receptor supports may be inserted into the locking groove in the footrest state, and the protrusion may be engaged with another one of the plurality of guide grooves, and the separate receptor may be supported on the upper side of the other one of the plurality of receptor supports in the footrest state.

Further, in the potty training device, a height of the wall may decrease toward the entrance.

Further, in the potty training device, the inducer receptor includes: an inducer receiving part providing the first inducer receiving space; and one or more separation walls disposed inside the inducer receiving part and dividing the first inducer receiving space into a plurality of receiving spaces.

Further, in the potty training device, the inducer receptor may be detachably coupled to the support body.

In accordance with a first embodiment of the present disclosure, there is provided an excrement processor including: the potty training device of any one of claims 1 to 12; and an excrement receptacle supporting the potty training device and receiving excrement of a pet defecating in the potty training device.

In accordance with a second embodiment of the present disclosure, there is provided an excrement processor includes: a potty training devices for defecation of a pet; and an excrement receptacle providing a defecation space configured to receive excrement of the pet, wherein the potty training device includes: a support plate supported on an upper side of the excrement receptacle and having a defecation hole through which excrement of the pet passes; an inducer receptor providing a first inducer receiving space in which a defecation inductor is contained; and a vertical support extending downward from the inducer receptor to be supported on the inside of the excrement receptacle, and supporting the support plate such that the inducer receptor is spaced apart from the support plate and located in the defecation hole.

Further, the excrement processor further includes one or more separate receptors detachably may be supported on one or more of an inner surface of the support plate, the inducer receptor, and an adjacent separate receptor, so as to be disposed between the support plate and the inducer receptor.

In accordance with a third embodiment of the present disclosure, there is provided an excrement processor including: a potty training devices for defecation of a pet; and an excrement receptacle providing a defecation space configured to receive excrement of the pet, wherein the potty training device includes: a support plate supported on an upper side of the excrement receptacle and having a defecation hole through which excrement of the pet passes; an inducer receptor providing a first inducer receiving space in which a defecation inducer is contained; and one or more horizontal supports extending from the support plate to the inducer receptor and supporting the support plate such that the inducer receptor is spaced apart from the support plate and located in the defecation hole.

According to embodiments of the present disclosure, it is possible to induce pets to defecate in a human toilet.

In addition, it is possible to reduce the amount of a defecation inducer required for defecation of pets.

### BRIEF DESCRIPTION OF THE DRAWINGS

FIG. 1 is a perspective view of a potty training device and an excrement processor including the same according to a first embodiment of the present disclosure.

FIG. 2 is an exploded perspective view of the potty training device of FIG. 1.

FIG. 3 is a bottom exploded perspective view of the potty training device of FIG. 1.

FIG. 4 is a bottom perspective view of the potty training device of FIG. 1.

FIG. 5 is a plan view of a support body of the potty training device according to the first embodiment of the present disclosure, viewed from above.

FIG. 6 is a perspective view of an inducer receptor of the potty training device according to the first embodiment of the present disclosure.

FIG. 7 is a perspective view of the inducer receptor of the potty training device according to the first embodiment of the present disclosure.

FIG. 8 is a bottom perspective view of a separate receptor of FIG. 6.

FIG. 9 is a perspective view of a second separate receptor of the potty training device of FIG. 1 converted to a footrest state.

FIG. 10 is a bottom perspective view of the potty training device of FIG. 9.

FIG. 11 is a perspective view of a first separate receptor of the potty training device of FIG. 9 converted to a footrest state.

FIG. 12 is a perspective view of a potty training device and an excrement processor including the same according to a second embodiment of the present disclosure.

FIG. 13 is a perspective view of a potty training device and an excrement processor including the same according to a third embodiment of the present disclosure.

### DETAILED DESCRIPTION OF EXEMPLARY EMBODIMENTS

Hereinafter, a potty training device 20 and an excrement processor 1 including the same according to a first embodiment of the present disclosure will be described.

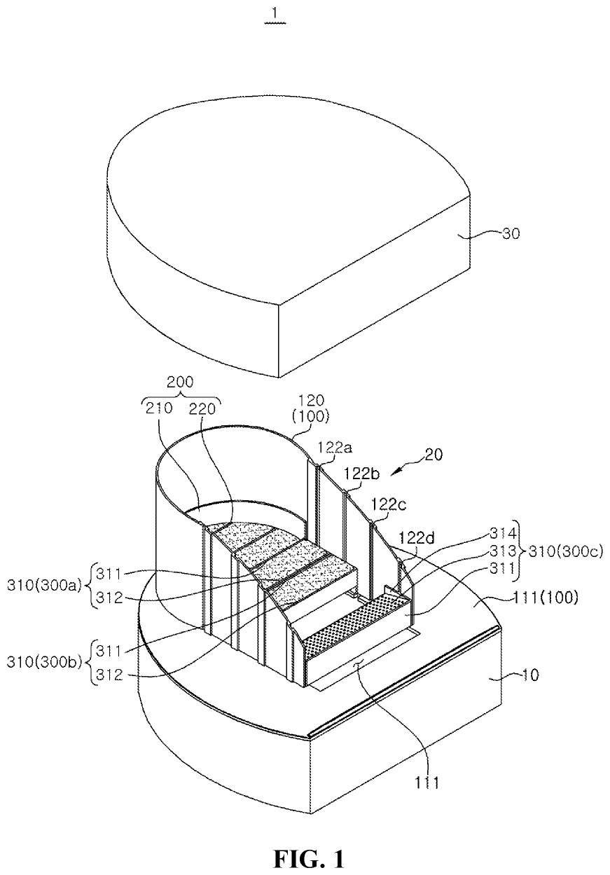

Referring to FIG. 1, the excrement processor 1 may be a device capable of receiving and processing excrement. The excrement processor 1 may be a toilet seat used by people or a pet toilet for processing pet feces. The excrement processor 1 may include one or more of an excrement receptacle 10, the potty training device 20, and a cover 30. Meanwhile, in an embodiment of the present disclosure, a pet that defecates in the potty training device 20 may be a cat, but is not limited thereto and may be any animal that can live with humans.

The excrement receptacle 10 may provide a space for receiving pet excrement. The excrement receptacle 10 may form the appearance of the excrement processor 1. For example, the excrement receptacle 10 may be a human toilet or a pet toilet. In addition, the excrement receptacle 10 may contain water for treating excrement.

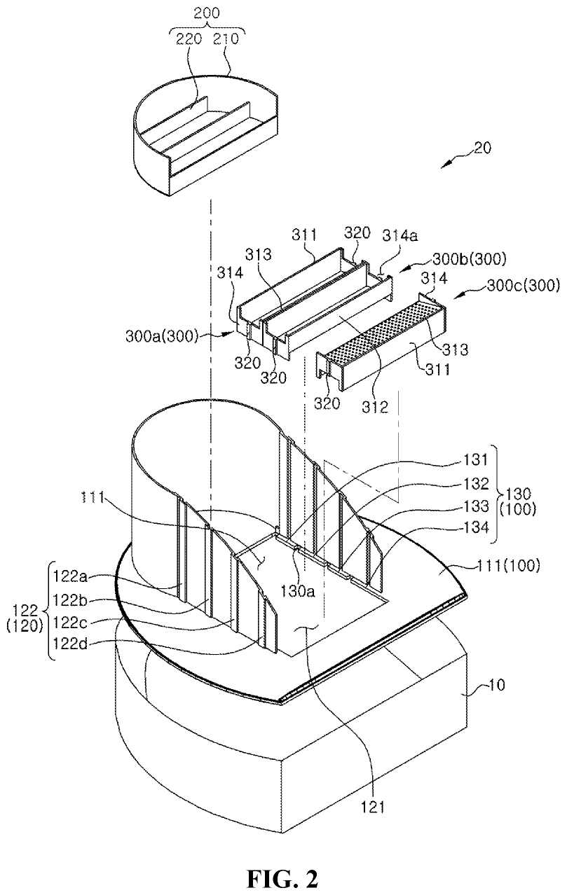

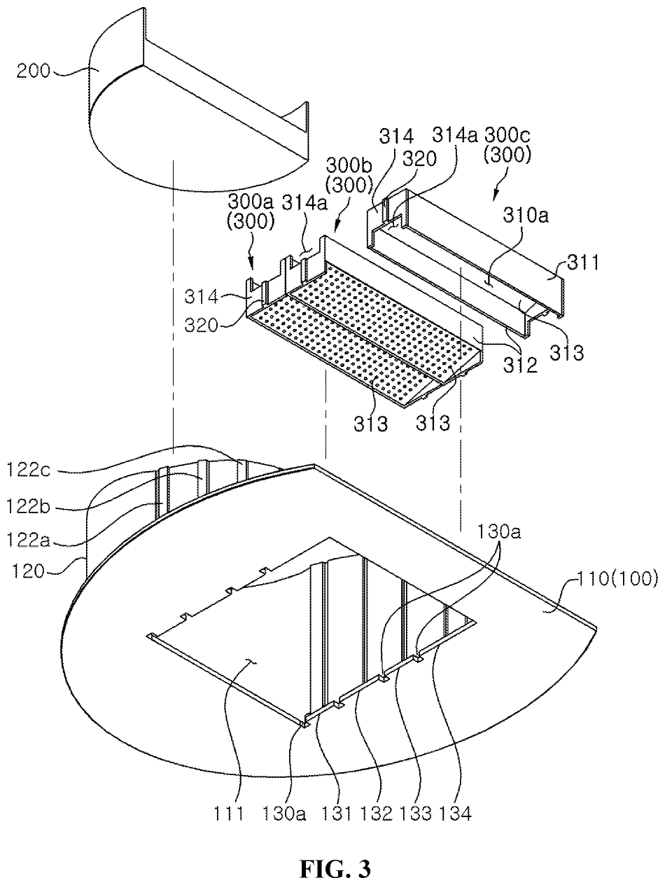

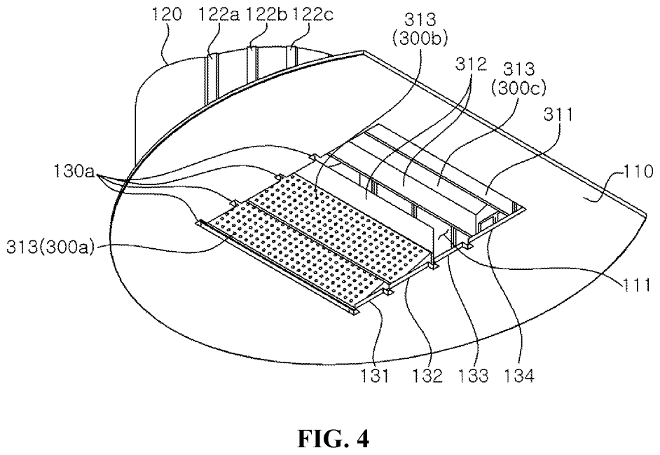

Referring to FIG. 2 to FIG. 4, the potty training device 20 is a device that is supported on the excrement receptacle 10 and can induce defecation of pets. For example, the potty training device 20 may be supported on the seat of a toilet seat. The potty training device 20 may include one or more of a support body 100, an inducer receptor 200, and a separate receptor 300.

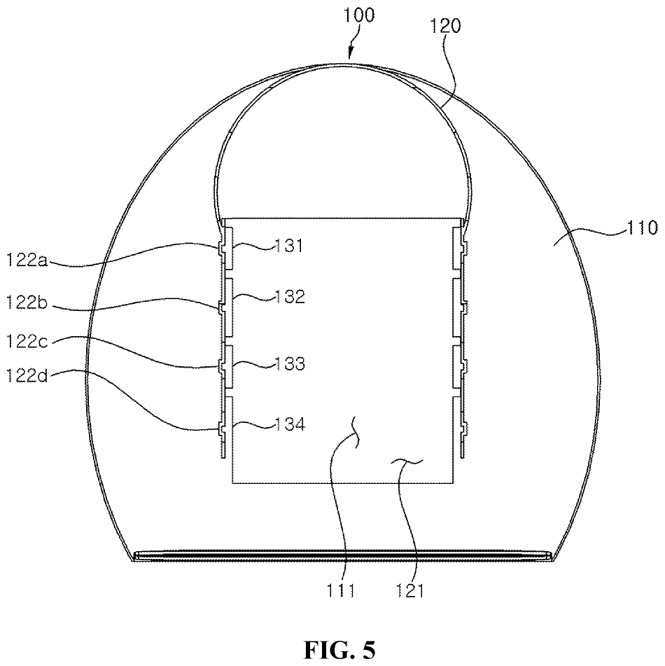

Referring to FIG. 5, the support body 100 may provide an internal space where pets can enter and defecate. The support body 100 may be detachably coupled to the excrement receptacle 10. For example, the support body 100 may be detachably supported on the excrement receptacle 10 using an adhesive, stickers, Velcro, hooks, an anti-slip pad, etc. The support body 100 may include a support plate 110, a wall 120, and a receptor support 130.

The support plate 110 extends in the horizontal direction and may be supported on the upper side of the excrement receptacle 10. In addition, the support plate 110 may support the inducer receptor 200. A defecation hole 111 through which excrement of a pet defecating in the internal space of the support body 100 can pass may be formed in the support plate 110. The excrement of a pet that has passed through the defecation hole 111 can be received in the excrement receptacle 10. Although the defecation hole 111 is shown as having a square shape in the present disclosure, the defecation hole 111 is not limited thereto and may be formed in various shapes such as a circle and a polygon as long as a pet excrement can pass through it. In addition, although there is one defecation hole 111 in the support plate 110 in the present disclosure, the present disclosure is not limited thereto and a plurality of defecation holes 111 may be formed. In other words, the inducer receptor 200 may be disposed between a plurality of defecation holes 111.

The wall 120 may protrude upward from the upper surface of the support plate 110 to accommodate the inducer receptor 200. In other words, the wall 120 may be formed to surround the outer surface of the inducer receptor 200. The wall 120 may form the internal space of the support body 100. An entrance 121 through which pets can enter and exit may be formed on one side of the wall 120. In other words, pets can enter and exit the internal space of the support body 100 through the entrance 121. At least a portion of the wall 120 may extend in the horizontal direction such that the entrance 121 is closer to the defecation hole 111 than the other side opposite to one side. In other words, the entrance 121 may be placed near the defecation hole 111. According to the wall 120 having this structure, when a pet enters and defecates inside the wall 120, the pet's head faces the other side of the wall 120 and the pet's buttocks faces the entrance 121, and thus pet excrement may fall into the defecation hole 111. Hereinafter, the direction in which the head of a pet defecating in the internal space of the support body 100 faces is referred to as a front side, and the direction in which the buttocks of the pet face is referred to as a rear side.

In other words, at least a portion of the wall 120 may extend in the front-rear direction to overlap the defecation hole 111 when the entrance 121 is viewed from above, but the present disclosure is not limited thereto, and the entrance 121 may be formed to be positioned further forward than the front side of the defecation hole 111 or to be positioned further rear than the rear side of the defecation hole 111. In addition, the front side of the wall 120 may be formed as a curved surface along the outer surface of the inducer receptor 200. The height of the wall 120 may gradually decrease toward the entrance 121.

In addition, a guide groove 122 that engages with the separate receptor 300 may be formed on the inner surface of the wall 120. The guide groove 122 may be recessed in the left-right direction from the inner surface of the wall 120 and may extend in the up-down direction, but is not limited thereto. In other words, at least a portion of the guide groove 122 may extend in the up-down direction, and another portion of the guide groove 122 may extend in the front-rear direction. With such guide groove 122, the separate receptor 300 may be coupled to or separated from the support body 100 while moving and sliding in the up-down direction or moving in the front-rear direction in the internal space of the support body 100. The guide groove 122 may be formed in the wall 120 to be positioned between the entrance 121 of the wall 120 and the inducer receptor 200.

In addition, a plurality of guide grooves 122 may be formed. The plurality of guide grooves 122 may be disposed to be spaced apart from each other in the front-rear direction. The lengths of the plurality of guide grooves 122 in the up-down direction may decrease toward the entrance 121 of the wall 120. The plurality of guide grooves 122 may include a first guide groove 122a, a second guide groove 122b, a third guide groove 122c, and a fourth guide groove 122d.

The first guide groove 122a may be disposed closer to the inducer receptor 200 than the second guide groove 122b, the third guide groove 122c, and the fourth guide groove 122d. In addition, the length of the first guide groove 122a in the up-down direction may be greater than those of the second guide groove 122b, the third guide groove 122c, and the fourth guide groove 122d.

The second guide groove 122b may be disposed between the first guide groove 122a and the third guide groove 122c. The length of the second guide groove 122b in the up-down direction may be greater than those of the third guide groove 122c and the fourth guide groove 122d.

The third guide groove 122c may be disposed between the second guide groove 122b and the fourth guide groove 122d. The length of the third guide groove 122c in the up-down direction may be greater than that of the fourth guide groove 122d.

The fourth guide groove 122d may be disposed closer to the entrance 121 than the first guide groove 122a, the second guide groove 122b, and the third guide groove 122c. The length of the fourth guide groove 122d in the up-down direction may be less than those of the first guide groove 122a, the second guide groove 122b, and the third guide groove 122c.

Meanwhile, although one entrance 121 is formed in the wall 120 in the present disclosure, the present disclosure is not limited thereto. In other words, entrances 121 may be formed on one side and the other side of the wall 120 such that pets can enter and exit the internal space of the support body 100 through one side and the other side of the wall 120.

The receptor support 130 may support the separate receptor 300 such that the separate receptor 300 is located in the internal space of the support body 100. The receptor support 130 can prevent the separate receptor 300 from passing through the defecation hole 111 to fall into the excrement receptacle 10. The receptor support 130 may protrude in the left-right direction from the inner surface of the support plate 110 and extend in the front-rear direction. The protruding length of the receptor support 130 in the left-right direction may be less than the length of the separate receptor 300 in the left-right direction. The receptor support 130 may be disposed inside the wall 120 when viewed from the top.

In addition, a plurality of receptor supports 130 may be provided. The plurality of receptor supports 130 may be disposed to be spaced apart from each other in the front-rear direction to form a plurality of gaps 130a. The plurality of receptor supports 130 may be disposed on the lower sides of the guide grooves 122. The number of receptor supports 130 may be the same as the number of guide grooves 122, but the present disclosure is not limited thereto. In addition, at least one of the plurality of receptor supports 130 in the front-rear direction may be formed differently from the other ones. The plurality of receptor supports 130 may include a first receptor support 131, a second receptor support 132, a third receptor support 133, and a fourth receptor support 134.

The first receptor support 131 may be disposed closer to the inducer receptor 200 than the second receptor support 132, the third receptor support 133, and the fourth receptor support 134. The length of the first receptor support 131 in the front-rear direction may be less than the length of the second receptor support 132 or the length of the fourth receptor support 134 in the front-rear direction, but the present disclosure is not limited thereto. In addition, the first receptor support 131 may be disposed on the lower side of the first guide groove 122a.

The second receptor support 132 may be disposed between the first receptor support 131 and the third receptor support 133. The length of the second receptor support 132 in the front-rear direction may be greater than the lengths of the first receptor support 131 and the third receptor support 133 in the front-rear direction, but the present disclosure is not limited thereto. In addition, the second receptor support 132 may be disposed on the lower side of the second guide groove 122b.

The third receptor support 133 may be disposed between the second receptor support 132 and the fourth receptor support 134. In addition, the third receptor support 133 may be disposed on the lower side of the third guide groove 122c.

The fourth receptor support 134 may be disposed closer to the entrance 121 of the wall 120 than the first receptor support 131, the second receptor support 132, and the third receptor support 133. In addition, the fourth receptor support 134 may be disposed on the lower side of the fourth guide groove 122d.

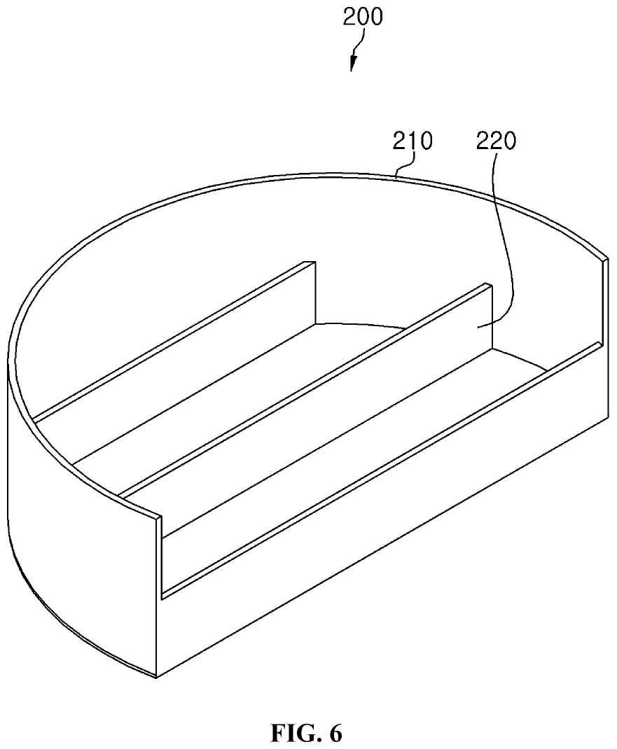

Referring further to FIG. 6, the inducer receptor 200 is disposed in the internal space of the support body 100 and can contain a defecation inducer. The defecation inducer may include a substance for inducing defecation of pets. In other words, the defecation inducer may include at least one of sand and gravel, but the present disclosure is not limited thereto and the defecation inducer may be formed of various substances or may take various forms which can induce defecation of pets. The inducer receptor 200 may be fixed to the support body 100 or may be detachably disposed. The inducer receptor 200 may include an inducer receiving part 210 and a separation wall 220.

The inducer receiving part 210 may provide a first inducer receiving space capable of receiving the defecation inducer. In other words, the upper side of the inducer receiving part 210 may be opened to receive the defecation inducer. A portion of the outer surface of the inducer receiving part 210 may be surrounded by the wall 120. The height of the inducer receiving part 210 may be formed to be less than the height of the wall 120. The inducer receiving part 210 may be moved in the up-down direction along the inner surface of the wall 120 to be coupled to or separated from the support body 100.

One or more separation walls 220 may be provided and disposed inside the inducer receiving part 210 to divide the first inducer receiving space into a plurality of spaces. For example, the separation wall 220 may be disposed to extend in the left-right direction inside the inducer receiving part 210, but is not limited thereto. In additionally, the separation wall 220 may be disposed to be separable from the inducer receiving part 210.

In addition, a portion of the separation wall 220 or a portion of the inducer receiving part 210 partitioned by the separation wall 220 may extend upward or may be deformed to extend upward, and the extending height may be equal to or greater than the height of the wall 120. The separation wall 220 extending upward in this manner can serve to reduce the area of the first inducer receiving space.

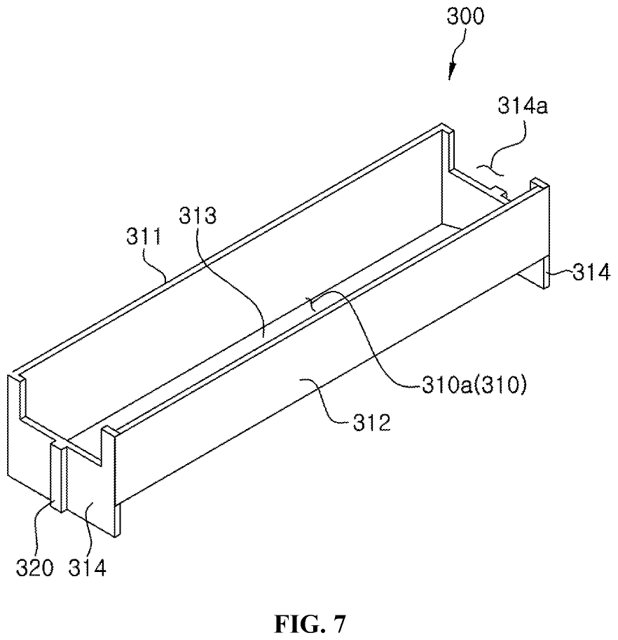

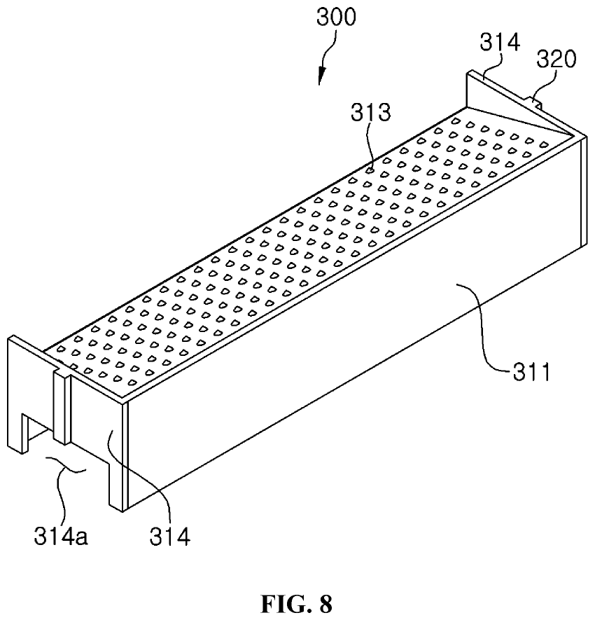

Referring further to FIG. 7 and FIG. 8, the separate receptor 300 may receive a defecation inducer. The defecation inducer contained in the separate receptor 300 may be the same as the defecation inducer contained in the inducer receptor 200, but the present disclosure is not limited thereto and the defecation inducers may be formed of different substances or may take different forms. For example, sand may be contained in the separate receptor 300, and gravel may be contained in the inducer receptor 200. The separate receptor 300 may be detachably coupled to the support body 100 to be aligned with the inducer receptor 200 in the front-rear direction in the internal space of the support body 100. In other words, the separate receptor 300 may be coupled to the wall 120 to be disposed behind the inducer receptor 200. In addition, the separate receptor 300 may be coupled to the wall 120 to overlap the defecation hole 111 when viewed from above.

The separate receptor 300 may be coupled to the support body 100 in an inducer receiving state or a footrest state. In other words, the separate receptor 300 may be engaged with any one of the plurality of guide grooves 122 and disposed in the inducer receiving state or the footrest state. The inducer receiving state is a state in which the separate receptor 300 is coupled to the support body 100 to receive the defecation inducer in a second inducer receiving space. The footrest state is a state in which the separate receptor 300 is coupled to the support body 100 to support a pet that has entered and exited the internal space of the support body 100.

In addition, a plurality of separate receptors 300 may be provided. The number of separate receptors 300 may be less than the number of guide grooves 122 such that pet excrement is received in the excrement receptacle 10 through the defecation hole 111, but the present disclosure is not limited thereto. When any one of the plurality of separate receptors 300 is engaged with any one of the plurality of guide grooves 122, another one of the plurality of separate receptors 300 may be engaged with another one of the plurality of guide grooves 122. In addition, one of the plurality of separate receptors 300 and another one engaged with the guide grooves 122 may be disposed to be spaced apart from each other such that pet excrement passes through the defecation hole 111 to be received in the excrement receptacle 10. The separate receptor 300 may include a separate receiving part 310 and a protrusion 320.

The separate receiving part 310 may provide the second inducer receiving space in which the defecation inducer is contained. An opening 310a may be formed such that the defecation inducer of the separate receiving part 310 is received in the second inducer receiving space. When the separate receptor 300 is fastened to the wall 120, the separate receiving part 310 may be supported on the receptor support 130.

In addition, the separate receiving part 310 may be disposed such that the opening 310a faces upward in the inducer receiving state. The separate receiving part 310 may be disposed such that the opening 310a faces downward in the footrest state. In other words, when the separate receiving part 310 is turned over in the inducer receiving state and fastened to the support body 100, the separate receiving part 310 can be converted to the foothold state. When the separate receiving part 310 is in the footrest state, the defecation inducer is not received in the second inducer receiving space. In addition, the lower side of the separate receiving part 310 in the inducer receiving state may be used as a footrest by a pet entering and exiting the support body 100 in the footrest state. The separate receiving part 310 may include a first separation plate 311, a second separation plate 312, a third separation plate 313, and a fourth separation plate 314.

The first separation plate 311 may extend in the left-right direction and may be disposed to be spaced apart from the second separation plate 312 in the front-rear direction. The first separation plate 311 can prevent the defecation inducer from escaping from the second inducer receiving space.

The second separation plate 312 may extend in the left-right direction. The height of the second separation plate 312 may be equal to or less than the height of the first separation plate 311. The second separation plate 312 can prevent the defecation inducer from escaping from the second inducer receiving space.

The third separation plate 313 may extend in the left-right direction and in the front-rear direction to be connected to the first separation plate 311 and the second separation plate 312. In other words, one side of the third separation plate 313 may be connected to the first separation plate 311, and the other side opposite to the one side may be connected to the second separation plate 312.

The defecation inducer may be supported on one surface of the third separation plate 313 in the inducer receiving state. In other words, one surface of the third separation plate 313 may form the bottom surface of the separate receiving part 310 in the inducer receiving state. In addition, the other surface opposite to the one surface of the third separation plate 313 may support a pet in the footrest state. In other words, in the footrest state, the other surface of the third separation plate 313 may be located higher than the one surface and serve as a footrest. The other surface of the third separation plate 313 may be provided with an anti-slip pad or an anti-slip protrusion to prevent pets from slipping.

In addition, the third separation plate 313 may be disposed at an angle such that one side thereof is located lower than the other side in the inducer receiving state and the one side is located higher than the other side in the footrest state. For example, the third separation plate 313 may be disposed such that one side thereof is positioned ahead of the other side when the separate receptor 300 is engaged with the first guide groove 122a and is in the footrest state and may be disposed such that the other side is positioned ahead of one side when the separate receptor 300 is engaged with the third guide groove 122c or the fourth guide groove 122d and is in the footrest state. When the third separation plate 313 is in the footrest state, even if pet excrement falls on the third separation plate 313, it may flow or roll towards the defecation hole 111 to be received in the excrement receptacle 10.

The fourth separation plate 314 may be supported on the receptor support 130 in the inducer receiving state or footrest state. The inducer receptor 210 may be supported on the receptor support 130 by the fourth separation plate 314. The fourth separation plate 314 is connected to the edges of the first separation plate 311, the second separation plate 312, and the third separation plate 313 and may support the protrusion 320. In other words, the protrusion 320 may protrude from the outer surface of the fourth separation plate 314.

The fourth separation plate 314 may be supported on the upper side of any one of the plurality of receptor supports 130 in the inducer receiving state. In addition, a locking groove 314a may be formed in the fourth separation plate by being recessed downward from the top in the inducer receiving state. The receptor support 130 may be inserted into the locking groove 314a. In other words, when the fourth separation plate 314 is in the footrest state, the receptor support 130 can be inserted into the locking groove 314a.

As a first example, when the protrusion 320 is engaged with any one of the plurality of guide grooves 122 in the footrest state, any one of the plurality of receptor supports 130 may be inserted into the locking groove 314a. In other words, when the protrusion 320 is engaged with the first guide groove 122a, the first receptor support 131 can be inserted into the locking groove 314a. In addition, when the protrusion 320 is engaged with the third guide groove 122c, the third receptor support 133 can be inserted into the locking groove 314a.

As a second example, when the protrusion 320 is engaged with another one of the plurality of guide grooves 122 in the footrest state, the another one of the plurality of receptor supports 130 is not inserted into the locking groove 314a and may support the fourth separation plate 314 disposed thereon. In other words, when the protrusion 320 is engaged with the second guide groove 122b, the fourth separation plate 314 can be supported on the upper side of the second receptor support 132. In additionally, when the protrusion 320 is engaged with the fourth guide groove 122d, the fourth separation plate 314 can be supported on the upper side of the fourth receptor support 134. Further, the third separation plate 313 in the footrest state in the second example may be disposed above the third separation plate 313 in the footrest state in the first example.

The first separation plate 311, the second separation plate 312, the third separation plate 313, and the fourth separation plate 314 may be connected to each other to form the second inducer receiving space.

The protrusion 320 may protrude from the outer surface of the separate receiving part 310 and may be engaged with the guide groove 122 when the separate receptor 300 is fastened to the support body 100. In other words, the protrusion 320 may protrude in the left-right direction from the fourth separation plate 314 when the separate receiving part 310 is supported on the receptor support 130. By this protrusion 320, the separate receiving part 310 can be slid in the extending direction of the guide groove 122 and removed from or coupled to the support body 100.

Meanwhile, the plurality of separate receptors 300 may include a first separate receptor 300a, a second separate receptor 300b, and a third separate receptor 300c. For example, the first separate receptor 300a may be engaged with the first guide groove 122a in the inducer receiving state or the footrest state. In addition, the second separate receptor 300b may be engaged with the second guide groove 122b in the inducer receiving state or may be engaged with the third guide groove 122c in the footrest state. In addition, the third separate receptor 300c may be engaged with the fourth guide groove 122d in the footrest state.

The cover 30 may cover the potty training device 20. The cover 30 can prevent the potty training device 20 from being exposed to the outside. For example, the cover 30 may accommodate the potty training device 20 while being detachably coupled to the excrement receptacle 10 in the up-down direction. As another example, the cover 30 may be rotatably coupled to the excrement receptacle 10 to open or close the potty training device 20. An opening may be formed on one side of the cover 30. Due to this opening, a pet can access the potty training device 20 even when the potty training device 20 is covered by the cover 30.

Hereinafter, the operations and effects of the potty training device 20 and a toilet seat including the same according to the first embodiment of the present disclosure will be described.

Since the potty training device 20 according to the first embodiment of the present disclosure can be installed in a toilet seat used by people, it is possible to induce a pet to defecate in a human toilet seat.

In addition, since a plurality of separate receptors 300 can be detachably fastened to the support body 100, the number of separate receptors 300 fastened to the support body 100 may be adjusted depending on the adaptability of a pet to the potty training device 20 and the size of the pet.

Furthermore, a location where pet excrement falls may be set to the defecation hole 111 and the excrement receptacle 10 by removing the separate receptor 300 or arranging the separate receptor 300 in the footrest state.

That is, when a pet stands on the defecation inducer in the internal space of the support body 100, the position of the separate receptor 300 can be adjusted such that pet excrement does not fall into the inducers contained in the separate receptor 300 and the inducer receptor 200. In other words, the position and direction of the separate receptor 300 can be adjusted such that hind legs of a pet and an excrement falling position are not located simultaneously in the inner regions of the defecation inducers contained in the inducer receptor 200 and the separate receptor 300 due to the body structure of the pet.

In addition, since the pet's buttocks cannot face the front side while stepping on the inducer receptor 200 due to the wall 120, the pet's buttocks can face the entrance 121 and the pet excrement can fall into the defecation hole 111.

Furthermore, when a pet steps on the support plate 110 in the direction of the entrance 121 or the second separate receptor 300b or third separate receptor 300c in the direction of the entrance 121 instead of the inducer receptor 200 and defecates with the buttocks in the direction of the inducer receptor 200 containing the inducer, the position and direction of the separate receptor 300 can also be adjusted such that the pet excrement does not fall into the inducers contained in the separate receptor 300 and the inducer receptor 200.

In addition, the third separation plate 313 is tilted, and thus even if the excrement falls on the third separation plate 313, the excrement may flow or roll down into the defecation hole 111.

In addition, since the separate receptor 300 can be fastened to the support body 100 in the footrest state, a pet can safely use the potty training device 20.

Furthermore, the separation wall 220 of the inducer receptor 200 can prevent the defecation inducer from being separated from the inducer receptor 200 even if the pet scratches the defecation inducer.

When a pet performs defecation smoothly in the potty training device 20, the separate receptors 300 of the potty training device 20 may be sequentially removed or converted to a footrest state while maintaining a certain period of time. In addition, if a pet performs defecation smoothly through the potty training device 20 while the separate receptors 300 are sequentially removed, the separate receptors 300 may be completely removed from the potty training device 20. Thereafter, when the pet performs defecation smoothly through the potty training device 20 in which the inducer receptor 200 is not installed, the potty training device 20 is finally removed such that the pet can defecate through the excrement processor 1 without the potty training device 20. By sequentially removing the separate receptors 300 of the potty training device 20 or converting the same to the footrest state, the pet excrement falls directly into the defecation hole 111, and thus the defecation inducer is not contaminated. Further, since the pet's behavior of scratching the defecation inducer can be reduced, the amount of defecation inducer consumed during defecation can be considerably reduced.

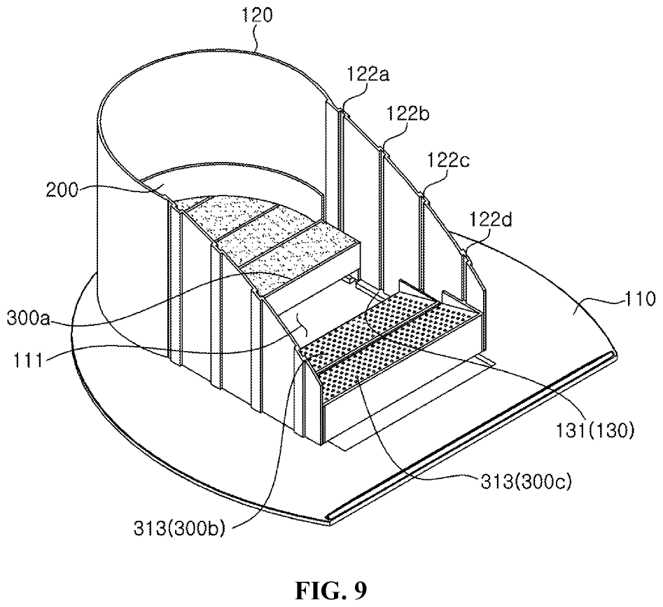

Hereinafter, a pet toilet training method using the potty training device 20 according to the first embodiment of the present disclosure will be described with reference to FIG. 9 to FIG. 11.

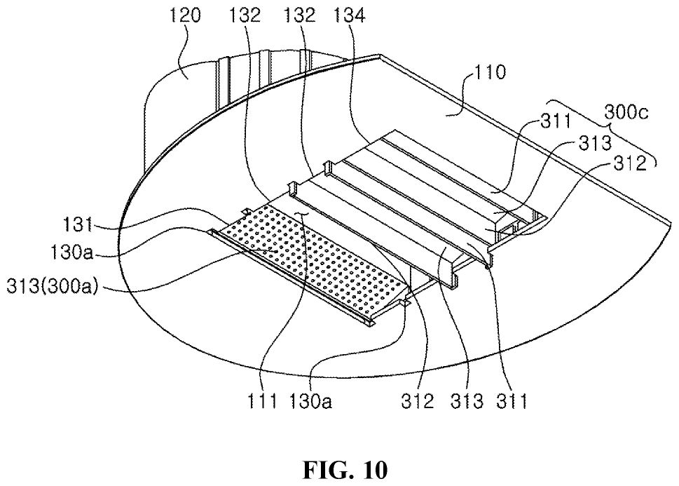

When a pet smoothly defecates and excrement is received in the excrement receptacle 10 through the defecation hole 111 in a state in which the first separate receptor 300a is engaged with the first guide groove 122a in the inducer receiving state, the second separate receptor 300b is engaged with the second guide groove 122b in the inducer receiving state, and the third separate receptor 300c is engaged with the fourth guide groove 122d in the footrest state, the second separate receptor 300b may be converted to the footrest state or separated from the support body 100. In other words, as shown in FIG. 9 and FIG. 10, the second separate receptor 300b may be converted to the footrest state and engaged with the third guide groove 122c. When the second separate receptor 300b is engaged with the third guide groove 122c in the footrest state, the third receptor support 133 is inserted into the locking groove 314a of the second separate receptor 300b, and thus the lower side of the fourth separation plate 314 may be disposed lower than the lower surface of the support plate 110.

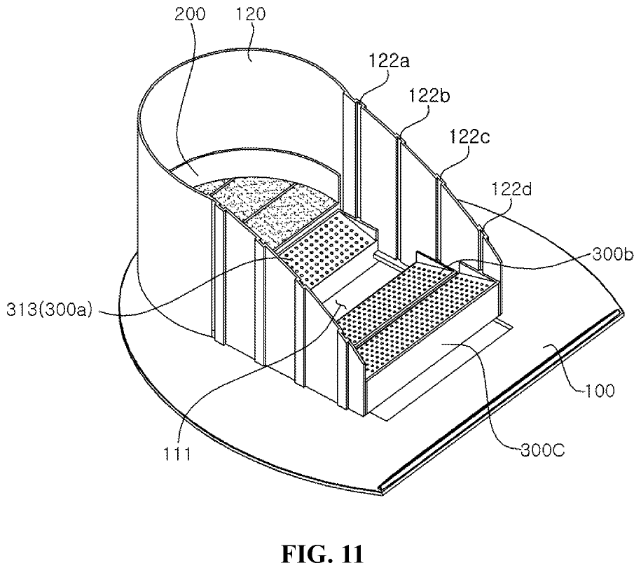

Thereafter, when the pet smoothly defecates and the excrement is received in the excrement receptacle 10 through the defecation hole 111, the first separate receptor 300a may be converted to the footrest state, as shown in FIG. 11. In other words, the first separate receptor 300a may be engaged with the first guide groove 122a in the footrest state. When the first separate receptor 300a is engaged with the first guide groove 122a in the footrest state, the first receptor support 131 is inserted into the locking groove 314a of the first separate receptor 300a and thus the lower side of the fourth separation plate 314 may be disposed lower than the lower surface of the support plate 110.

Thereafter, when the pet smoothly defecates and the excrement is received in the excrement receptacle 10 through the defecation hole 111, the defecation inducer may be contained in only a portion of the first inducer receiving space partitioned by the separation wall 220 of the inducer receptor 200 or the defecation inducer may be completely removed from the first inducer receiving space depending on the adaptability of the pet.

Meanwhile, the toilet training method described above is merely an example, and the state transition and position of the separate receptor 300 may be set differently depending on the size and adaptability of the pet.

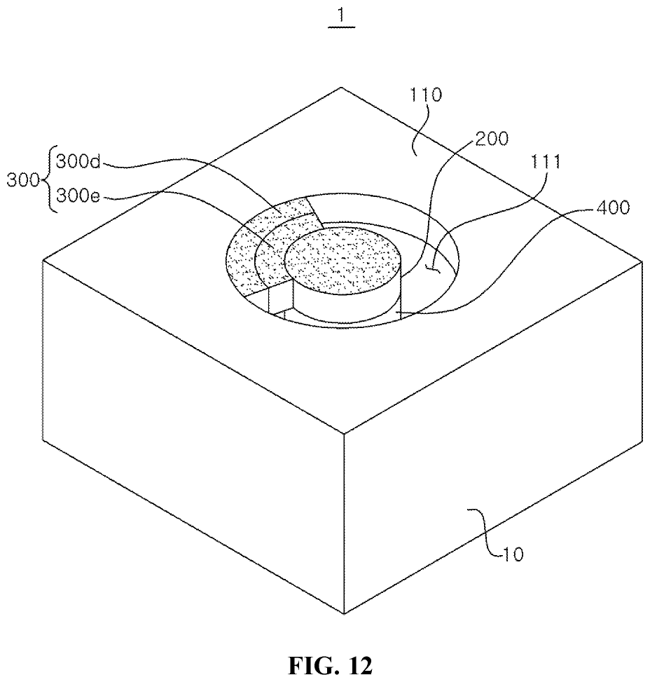

Hereinafter, a potty training device 20 and an excrement processor 1 including the same according to a second embodiment of the present disclosure will be described with reference to FIG. 12. The second embodiment differs from the first embodiment in that the potty training device 20 includes a vertical support 400, and description will focus on this difference.

The vertical support 400 may extend downward from the inducer receptor 200 and may be supported on the inside of the excrement receptacle 10. In addition, the vertical support 400 may support the inducer receptor 200 such that the inducer receptor 200 is spaced apart from the support plate 110 and located in the defecation hole 111. Due to the vertical support 400, the inducer receptor 200 can be located inside the area of the defecation hole 111 when viewed from above.

The separate receptor 300 may be located between the inducer receptor 200 and the support plate 110. In other words, the separate receptor 300 may be detachably supported on one or more of the inducer receptor 200 and the support plate 110 and disposed in the defecation hole 111. Additionally, the separate receptor 300 may be formed to extend along the inner surface of the support plate 110 or the outer shape of the inducer receptor 200. In other words, the separate receptor 300 may be disposed to surround at least a portion of the outer surface of the inducer receptor 200 when viewed from the top.

Additionally, a plurality of separate receptors 300 may be provided. One of the plurality of separate receptors 300 may be disposed closer to the support plate 110 than the others. Hereinafter, the separate receptor 300 disposed close to the support plate 110 among the plurality of separate receptors 300 is referred to as a fourth separate receptor 300d, and a separate receptor 300 disposed close to the inducer receptor 200 among the plurality of separate receptors 300 is referred to as a fifth separate receptor 300e.

The fourth separate receptor 300d may be disposed between the support plate 110 and the fifth separate receptor 300e and detachably supported on one or more of the support plate 110 and the fifth separate receptor 300e in an inducer receiving state or a foothold state. Additionally, the length of the fourth separate receptor 300d in the extension direction may be greater than the length of the fifth separate receptor 300e in the extension direction. Additionally, a plurality of fourth separate receptors 300d may be provided. The plurality of fourth separate receptors 300d may be arranged along the inner surface of the support plate 110. For example, the number of fourth separate receptors 300d may be four. Additionally, the fourth separate receptor 300d may extend along the inner surface of the support plate 110 and have a donut shape without a start and end boundary.

The fifth separate receptor 300e may be disposed between the inducer receptor 200 and the fourth separate receptor 300d and detachably supported on one or more of the inducer receptor 200 and the fifth separate receptor 300e in the inducer receiving state or the footrest state. Additionally, a plurality of fifth separate receptors 300e may be provided. The plurality of fifth separate receptors 300e may be arranged along the outer surface of the inducer receptor 200. For example, the number of fifth separate receptors 300e may be four. Additionally, the fifth separate receptor 300e may extend along the outer surface of the inducer receptor 200 and have a donut shape without a start and end boundary.

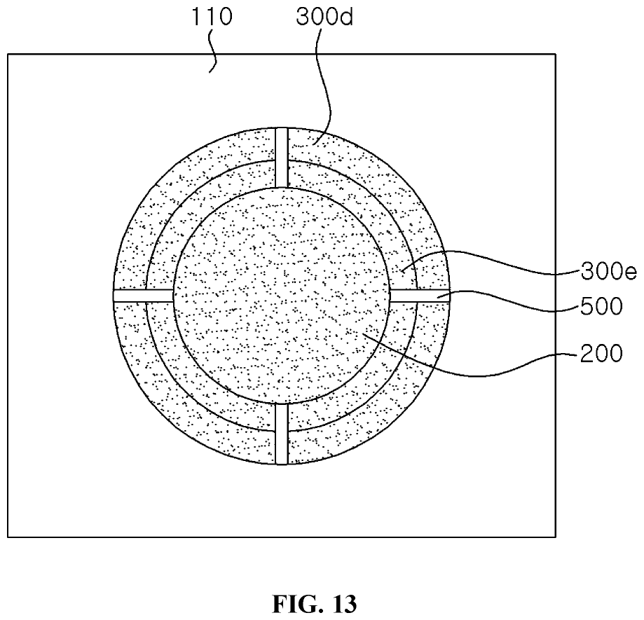

Hereinafter, a potty training device 20 and an excrement processor 1 including the same according to a third embodiment of the present disclosure will be described with reference to FIG. 13. The third embodiment differs from the above-described embodiments in that the potty training device 20 includes a horizontal support 500, and description will focus on this difference.

The horizontal support 500 may extend from the inner surface of the support plate 110 to the inducer receptor 200 to support the inducer receptor 200. Due to this horizontal support 500, the inducer receptor 200 can be placed inside the area of the defecation hole 111 of the support plate 110 when viewed from the top. In addition, a plurality of horizontal supports 500 may be provided and disposed to be spaced apart from each other along the inner surface of the support plate 110.

The separate receptor 300 may be supported on one or more of the support plate 110, the inducer receptor 200, and the horizontal support 500 and disposed in the defecation hole 111. Additionally, the fourth separate receptor 300d and the fifth separate receptor 300e may be disposed between the plurality of horizontal supports 500.

In the first embodiment of the present disclosure, the minimum condition for a pet excrement falling position to be the defecation hole 111 is determined by the width and length of the inducer receptor 200 in which the inducer is contained. In other words, the size of a pet that can use the potty training device is determined by the width and length of the inducer receptor 200. This is because a portion of the inducer receptor 200 is blocked by the wall 120. For example, if the inducer receptor 200 is adapted to small pets and the wall 120 is sufficiently high, a large pet is blocked by the wall 120 due to the defecation posture and the shape and thus cannot step on the inducer receptor 200 and assume a defecation posture.

On the other hand, in the second and third embodiments, since there is no obstacle such as the wall 120, a pet can assume a defecation posture as long as the pet can step on the inducer receptor 200. That is, when the excrement processor 1 has a specific fixed size, the range of sizes of pets that can use the excrement processor 1 may be wider in the second and third embodiments than in the first embodiment.

What is claimed is:

1. A potty training device comprising:
a support body providing an internal space where a pet is able to enter and defecate; and
an inducer receptor disposed in the internal space of the support body and providing a first inducer receiving space in which a defecation inducer is contained,
wherein the support body comprises:
a support plate supporting the inducer receptor on an upper surface thereof and having a defecation hole through which excrement of the pet passes; and
a wall protruding upward from the upper surface of the support plate to accommodate the inducer receptor and having an entrance formed on one side such that the pet is able to enter and exit the support body, and
wherein the entrance is disposed near the defecation hole.

2. The potty training device of claim 1, further comprising one or more separate receptors detachably coupled to the wall and providing a second inducer receiving space in which a defecation inducer is contained,
wherein the separate receptors are coupled to the wall to be located between the entrance and the inducer receptor.

3. The potty training device of claim 2, wherein at least a portion of the wall extends in a horizontal direction such that the entrance is disposed closer to the defecation hole than the other side opposite one side,
a guide groove extending in an up-down direction is formed on an inner surface of the wall, and
each separate receptor comprises:
a separate receiving part providing the second inducer receiving space and having an opening such that the defecation inducer is contained in the second inducer receiving space; and
a protrusion protruding from an outer surface of the separate receiving part toward the wall and engaged with the guide groove to slide in the up-down direction.

4. The potty training device of claim 3, wherein a plurality of guide grooves is provided,
the plurality of guide grooves is arranged to be spaced apart from each other in a direction in which the wall extends,
a plurality of separates receptor is provided, and
one of the plurality of separate receptors is engaged with one of the plurality of guide grooves, and another one of the plurality of separate receptors is engaged with another one of the plurality of guide grooves.

5. The potty training device of claim 3, wherein each separate receptor is coupled to the wall to be disposed in an inducer receiving state for receiving the defecation inductor in the second inducer receiving space or a footrest state for supporting the pet entering and exiting the internal space, and
the separate receiving part is disposed such that the opening faces upward in the inducer receiving state and disposed such that the opening faces downward in the footrest state.

6. The potty training device of claim 5, wherein the separate receiving part comprises:
a first separation plate;
a second separation plate disposed to be spaced apart from the first separation plate in the direction in which the wall extends;
a third separation plate connected to the first separation plate and the second separation plate; and
a fourth separation plate connected to edges of the first separation plate, the second separation plate, and the third separation plate and supporting the protrusion,
wherein the third separation plate is disposed such that the defecation inductor is supported on one surface in the inducer receiving state and disposed such that the pet is supported on the other surface opposite to the one surface in the footrest state.

7. The potty training device of claim 6, wherein one side of the third separation plate is connected to the first separation plate, the other side opposite the one side is connected to the second separation plate, and the third separation plate is disposed such that the one side is located lower than the other side in the inducer receiving state.

8. The potty training device of claim 6, wherein the support body further comprises a receptor support protruding from an inner surface of the support plate and extending in one direction to support the separate receptor, and
the fourth separation plate is supported on the receptor support in the inducer receiving state or the footrest state.

9. The potty training device of claim 8, wherein a plurality of receptor supports is provided and disposed to be spaced apart from each other in the one direction,
a plurality of guide grooves is provided, the plurality of guide grooves being disposed to be spaced apart from each other in the one direction,
the fourth separation plate has a locking groove formed to be recessed downward from the top in the inducer receiving state,
the protrusion is engaged with one of the plurality of guide grooves, and any one of the plurality of receptor supports is inserted into the locking groove in the footrest state, and
the protrusion is engaged with another one of the plurality of guide grooves, and the separate receptor is supported on the upper side of the other one of the plurality of receptor supports in the footrest state.

10. The potty training device of claim 3, wherein a height of the wall decreases toward the entrance.

11. The potty training device of claim 1, wherein the inducer receptor comprises:
an inducer receiving part providing the first inducer receiving space; and
one or more separation walls disposed inside the inducer receiving part and dividing the first inducer receiving space into a plurality of receiving spaces.

12. The potty training device of claim 1, wherein the inducer receptor is detachably coupled to the support body.

13. An excrement processor comprising:
the potty training device of claim 1; and
an excrement receptacle supporting the potty training device and receiving excrement of a pet defecating in the potty training device.

14. An excrement processor comprises:
a potty training devices for defecation of a pet; and
an excrement receptacle providing a defecation space configured to receive excrement of the pet,
wherein the potty training device comprises:
a support plate supported on an upper side of the excrement receptacle and having a defecation hole through which excrement of the pet passes;
an inducer receptor providing a first inducer receiving space in which a defecation inductor is contained; and
a vertical support extending downward from the inducer receptor to be supported on the inside of the excrement receptacle, and supporting the support plate such that the inducer receptor is spaced apart from the support plate and located in the defecation hole.

15. The excrement processor of claim 14, wherein the potty training device further comprises one or more separate receptors detachably supported on one or more of an inner surface of the support plate, the inducer receptor, and an adjacent separate receptor, so as to be disposed between the support plate and the inducer receptor.

16. An excrement processor comprising:
a potty training devices for defecation of a pet; and
an excrement receptacle providing a defecation space configured to receive excrement of the pet,
wherein the potty training device comprises:
a support plate supported on an upper side of the excrement receptacle and having a defecation hole through which excrement of the pet passes;
an inducer receptor providing a first inducer receiving space in which a defecation inducer is contained; and
one or more horizontal supports extending from the support plate to the inducer receptor and supporting the support plate such that the inducer receptor is spaced apart from the support plate and located in the defecation hole.
